(19) United States
(12) Patent Application Publication
(10) Pub. No.: US 2019/0061178 A1
(43) Pub. Date: Feb. 28, 2019

(54) ROBOT-MOTOR COOLING STRUCTURE

(71) Applicant: FANUC CORPORATION, Yamanashi (JP)

(72) Inventors: Shinya CHIKARA, Yamanashi (JP); Hiroaki YAMAMOTO, Yamanashi (JP)

(73) Assignee: FANUC CORPORATION, Yamanashi (JP)

(21) Appl. No.: 16/059,159

(22) Filed: Aug. 9, 2018

(30) Foreign Application Priority Data
Aug. 31, 2017 (JP) 2017-166352

(51) Int. Cl. B25J 19/00; B25J 9/04; H02K 9/02

(52) U.S. Cl. CPC B25J 19/0054; H02K 9/02; B25J 9/046

(57) ABSTRACT

Provided is a robot-motor cooling structure including: at least one heat dissipation member that is disposed on a surface of a motor for a robot and that is made of a material having higher thermal conductivity than the motor; and at least one fixing member that is made of an elastic material capable of being elastically deformed and that is disposed at a position so as to surround the motor together with the heat dissipation member. The heat dissipation member is brought into close contact with the surface of the motor by an elastic restoring force of the fixing member.

### CROSS-REFERENCE TO RELATED APPLICATIONS

This application is based on Japanese Patent Application No. 2017-166352, the content of which is incorporated herein by reference.

### FIELD

The present invention relates to a robot-motor cooling structure.

### BACKGROUND

In the related art, there is a known cooling structure in which, in order to prevent overheating caused by heat generation of a motor used in an industrial automatic instrument, such as a robot, a screw hole for fastening, with a bolt, a heat sink having fins for heat dissipation is provided in a side surface of the motor, and the heat transferred from the side surface of the motor to the heat sink is dissipated to the atmosphere via the fins (for example, see Japanese Unexamined Utility Model Application, Publication No. Hei 1-79356.

### SUMMARY

The present invention provides the following solutions.

One aspect of the present invention is directed to a robot-motor cooling structure including: at least one heat dissipation member that is disposed on a surface of a motor for a robot and that is made of a material having higher thermal conductivity than the motor; and at least one fixing member that is made of an elastic material capable of being elastically deformed and that is disposed at a position so as to surround the motor together with the heat dissipation member, wherein the heat dissipation member is brought into close contact with the surface of the motor by an elastic restoring force of the fixing member.

### BRIEF DESCRIPTION OF DRAWINGS

FIG. 1 is a perspective view showing a robot on which a robot-motor cooling structure according to one embodiment of the present invention has been mounted.

FIG. 2 is a perspective view showing the cooling structure shown in FIG. 1.

FIG. 3 is a plan view showing the cooling structure shown in FIG. 1.

FIG. 4 is a perspective view showing a state in which protecting plates are attached to the cooling structure shown in FIG. 1.

FIG. 5 is a plan view showing a first modification of the cooling structure shown in FIG. 1.

FIG. 6 is a plan view showing a second modification of the cooling structure shown in FIG. 1.

FIG. 7 is a plan view showing a third modification of the cooling structure shown in FIG. 1.

FIG. 8 is a plan view showing a fourth modification of the cooling structure shown in FIG. 1.

### DETAILED DESCRIPTION

A robot-motor cooling structure 1 according to one embodiment of the present invention will be described below with reference to the drawings.

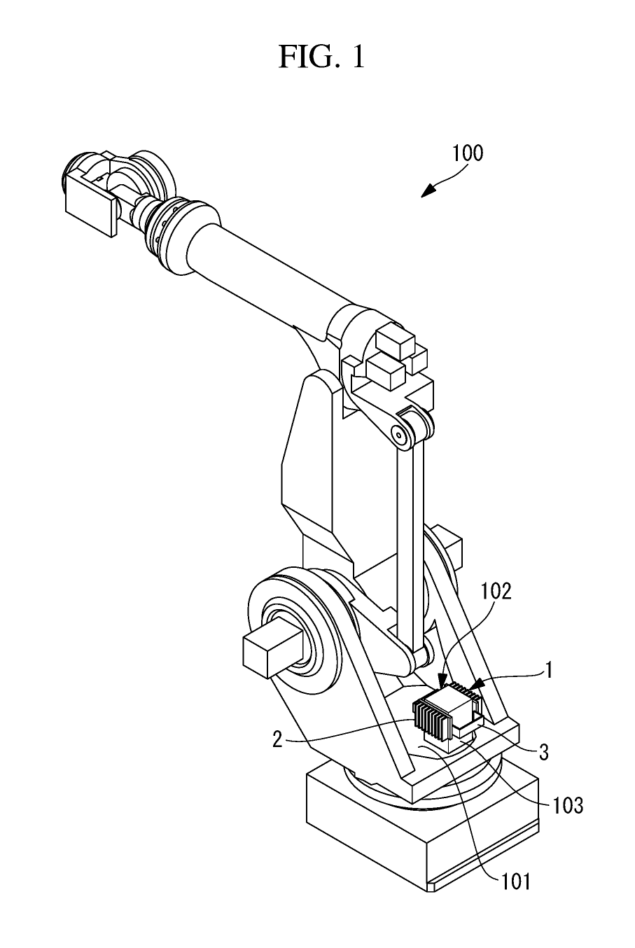

As shown in FIGS. 1 to 3, the robot-motor cooling structure 1 of this embodiment is mounted on a motor 102 that rotates a turning body 101 of a 6-axis articulated robot (hereinafter, simply referred to as robot) 100, for example, about a vertical axis.

The cooling structure 1 of this embodiment is provided with: two heat dissipation members 2 that are disposed on a pair of opposed side surfaces (hereinafter, also referred to as attachment surfaces) 103 of the regular-octagonal-prism motor 102; and fixing members 3 that attach the heat dissipation members 2 to the motor 102 and that bias the heat dissipation members 2 such that the heat dissipation members 2 are brought into close contact with the side surfaces (surfaces) 103 of the motor 102.

The heat dissipation members 2 are each provided with: a base section 4 that is formed of a thin metal plate; and a plurality of fins 5 that stand up perpendicularly on one surface of the base section 4 at regular intervals.

The respective heat dissipation members 2 are made of a material having higher thermal conductivity than a member that forms the surfaces of the motor 102, for example, a known metal material, such as aluminum or copper, an alloy material including such a metal material, or a material, such as oxide or nitride of such a metal material. Furthermore, the respective heat dissipation members 2 may also be subjected to surface treatment, such as an oxide film, so as to improve heat dissipation.

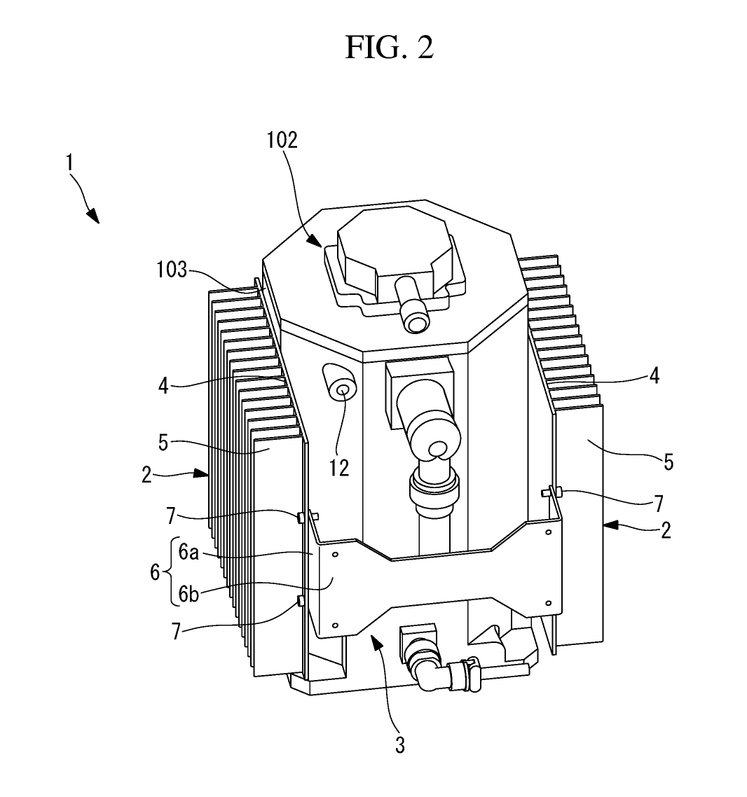

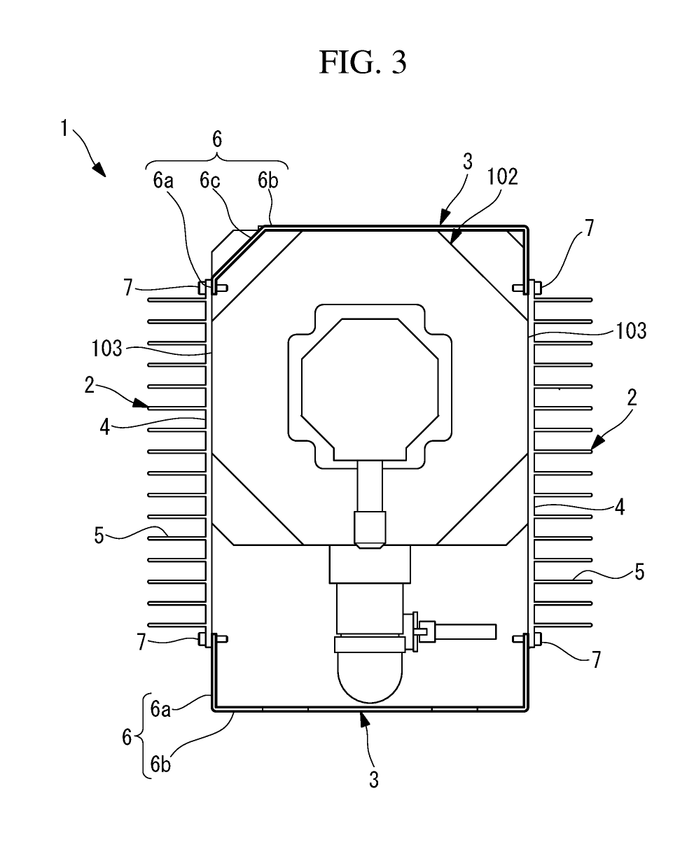

As shown in FIGS. 2 and 3, the fixing members 3 are provided with two fixing pieces 6 that are each obtained by bending both ends of a metal band plate that is made of a metal material having elasticity, substantially at a right angle, thereby being formed into a substantially U-shape that has substantially parallel end sections 6a and a connecting section 6b that connects the end sections 6a. Accordingly, the fixing members 3 form plate springs. The dimension between outer surfaces of the end sections 6a of each of the fixing pieces 6 is set slightly smaller than the dimension between the two attachment surfaces 103 of the motor 102. In FIG. 3, in order to avoid interference with another member, one of the fixing members 3 is provided with an inclined section 6c that is inclined at a smaller angle than 90° between one of the end sections 6a and the connecting section 6b. Specifically, the fixing members 3 may each have an arbitrary shape as long as it can form a plate spring.

Each of the fixing pieces 6 is provided with screw holes (not shown). Bolts 7 that are inserted into through-holes (not shown) provided at corresponding positions in the heat dissipation members 2 are tightened into the screw holes in the fixing members 3, thereby forming the two heat dissipation members 2 and the two fixing members 3 into a tube shape surrounding the motor 102. Then, in a state in which the base sections 4 of the two heat dissipation members 2 are respectively brought into contact with the two attachment surfaces 103 of the motor 102, when the fixing members 3 are fixed to the heat dissipation members 2 through tightening of the bolts 7, the two end sections 6a are elastically deformed in directions in which the space between the two end sections 6a is increased, because the connecting sections 6b of the fixing members 3 are set slightly smaller than the dimension between the attachment surfaces 103.

Accordingly, because the elastic restoring forces of the fixing members 3 that are being elastically deformed act in directions in which the two heat dissipation members 2 come closer to each other, the base sections 4 of the heat dissipation members 2 are respectively pressed against and are brought into close contact with the side surfaces 103 of the motor 102, which are disposed between the heat dissipation members 2. As a result, the two heat dissipation members 2 are held in a state in which the two heat dissipation members 2 are fixed to the two side surfaces 103 of the motor 102 due to the friction force, and the heat generated by the motor 102 is transferred to the base sections 4 of the heat dissipation members 2, which have been brought into close contact with the side surfaces 103.

Because the heat dissipation members 2 have higher thermal conductivity than the member that forms the surfaces of the motor 102, the heat transferred to the base sections 4 is rapidly conducted to the fins 5 and is easily dissipated into the air from the surface, which is expanded by the fins 5 and which has a large surface area.

Accordingly, the heat generated by the motor 102 is efficiently dissipated, thus making it possible to effectively cool the motor 102.

In this case, according to the cooling structure 1 of this embodiment, because the two heat dissipation members 2 are fixed, in an attached state, to the motor 102 by the fixing members 3 due to the elastic restoring forces thereof, and the base sections 4 of the heat dissipation members 2 are brought into close contact with the side surfaces 103 of the motor 102, screw holes for attaching the heat dissipation members 2 to the side surfaces 103 of the motor 102 need not be prepared in the surfaces of the motor 102. As a result, there is an advantage in that screw holes need not be machined in a part that constitutes the motor 102, and time and effort for machining can be saved. Accordingly, the heat dissipation members 2 can also be easily fixed to a general-purpose motor in which screw holes are not particularly prepared.

In this embodiment, as shown in FIGS. 2 and 3, although the lengths of the base sections 4 of the heat dissipation members 2 are made to be larger than the widths of the attachment surfaces 103 of the motor 102, and the base sections 4 of the heat dissipation members 2 are disposed so as to protrude from the attachment surfaces 103 in one width direction, this is because interference with other component parts of the robot 100 is avoided. Instead of this, the base sections 4 may also be formed so as to have the same widths as the attachment surfaces 103, thus being matched with the attachment surfaces 103, and may be attached thereto.

In a case in which the base sections 4 are disposed so as to protrude from the attachment surfaces 103 in one width direction, there is an advantage in that a large surface area for heat dissipation into the air can be ensured, thus making it possible to improve the heat dissipation efficiency. Furthermore, because the elastic restoring forces of the fixing members 3 are amplified due to the lever principle, there is also an advantage in that the degree of close contact between the heat dissipation members 2 and the attachment surfaces 103 of the motor 102 is increased, thus making it possible to improve the heat-transfer efficiency. Furthermore, there is also an advantage in that the heat dissipation members 2 are made to protrude to positions where the heat dissipation members 2 are efficiently brought into contact with air due to the movement of the robot 100, thus making it possible to improve the heat dissipation efficiency.

Furthermore, as shown in FIGS. 2 and 3, because the heat dissipation members 2 have the fins 5 disposed so as to extend along the vertical direction, it is possible to improve the heat dissipation effect due to natural convection of air.

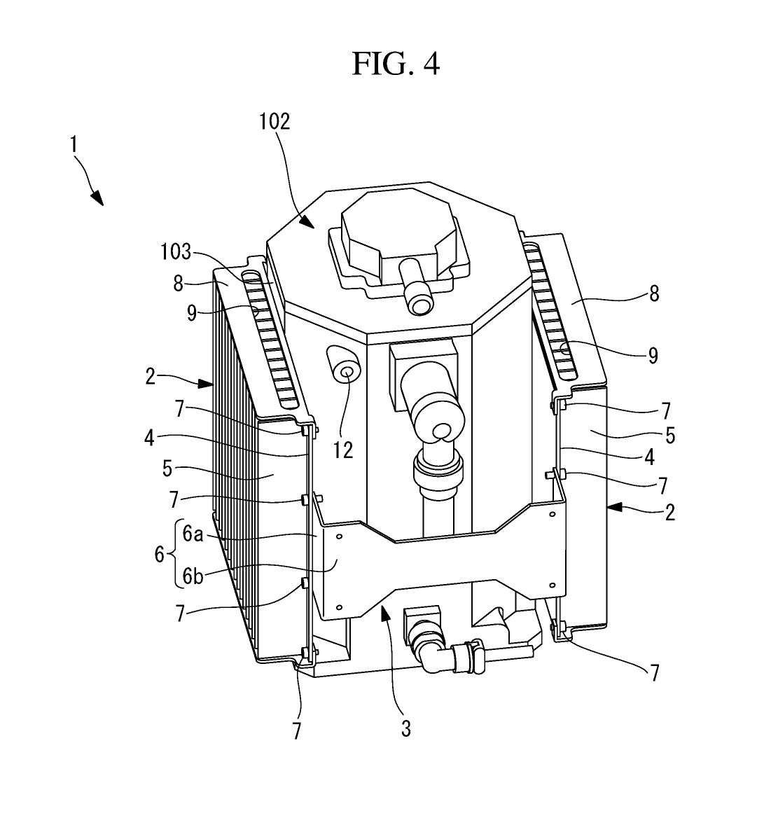

Note that, as shown in FIGS. 2 and 3, in the heat dissipation members 2, in each of which the plurality of fins 5 are arrayed, the edges of the many fins 5 are disposed around the motor 102; thus, in order to ensure the ease of performing work around the motor 102, it is also possible to dispose protecting plates 8 that cover ends of the fins 5, as shown in FIG. 4.

Outer peripheral surfaces of the protecting plates 8 are subjected to round chamfering, and thus, the protecting plates 8 each have a shape with no edge. Accordingly, the edges of the fins 5 are covered with the protecting plates 8, thus making it possible to improve the ease of performing work around the motor 102.

Note that through-holes 9 are provided in the protecting plates 8, thereby making it possible to allow air flowing upward between the fins 5 due to the natural convection to escape upward from the through-holes 9 and to prevent the heat dissipation performance from being impaired.

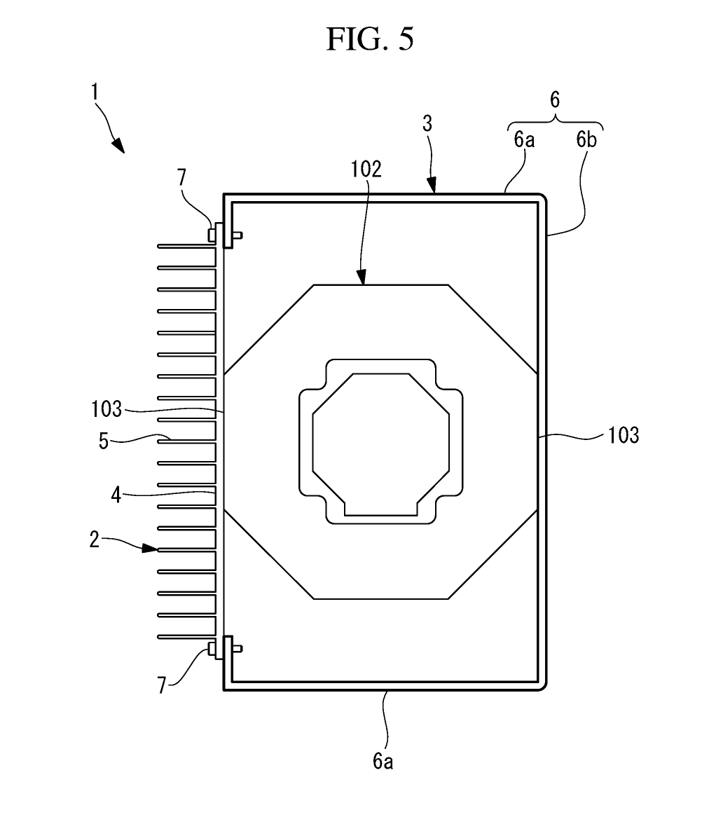

Furthermore, in this embodiment, although a description has been given of a case in which the two heat dissipation members 2 are attached to the motor 102 so as to sandwich the motor 102 therebetween, instead of this, as shown in FIG. 5, it is also possible to attach a single heat dissipation member 2 to the motor 102 by using a single fixing member 3. In this case, the fixing member 3 also forms a plate spring, and the heat dissipation member 2 is biased by the elastic restoring force of the fixing member 3 so as to be brought into close contact with the motor 102, thereby making it possible to maintain a state in which the heat dissipation member 2 is attached to the motor 102 due to the friction force.

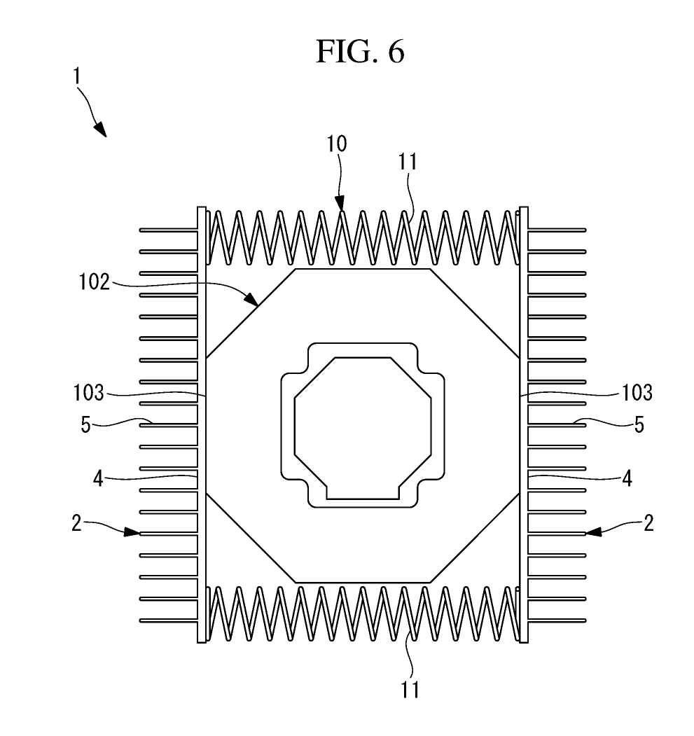

Furthermore, instead of the fixing members 3, which form plate springs, as shown in FIG. 6, it is also possible to adopt, between the two heat dissipation members 2, a fixing member 10 that is constituted of two tension coil springs 11 that bias the heat dissipation members 2 in directions in which the heat dissipation members 2 come closer to each other. With the coil springs 11, it is possible to easily produce large elastic restoring forces and to easily achieve attachment of the fixing member 10 and a high degree of close contact with respect to the surfaces of the motor 102.

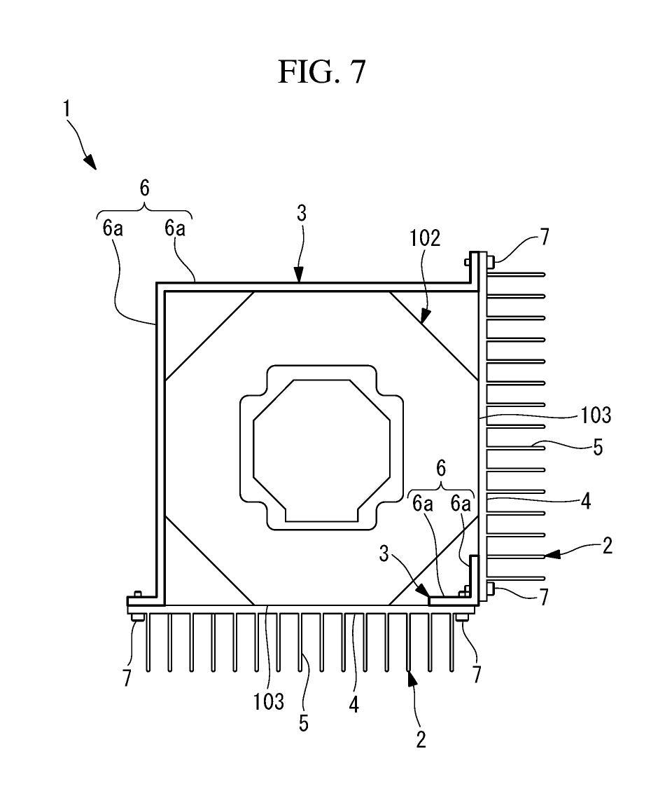

Furthermore, instead of disposing the two heat dissipation members 2 on the opposed side surfaces 103 with the motor 102 sandwiched therebetween, as shown in FIG. 7, it is also possible to attach the two heat dissipation members 2 to two side surfaces 103 of the motor 102 that are perpendicular to each other. In this case, fixing pieces 6 in each of which end sections 6a are connected without having a connecting section 6b are used as the fixing members 3.

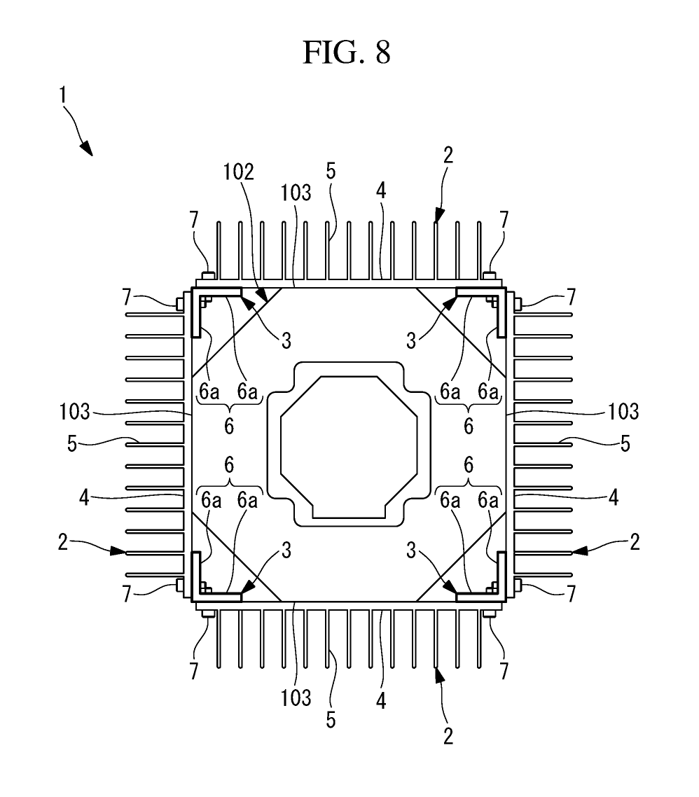

Furthermore, as shown in FIG. 8, it is also possible to attach four heat dissipation members 2 to four side surfaces 103 of the motor 102 that are perpendicular to each other.

In any of the cases, because the fixing member 3 biases, due to the elastic restoring force, the heat dissipation member 2 so as to press the heat dissipation member 2 against the surface of the motor 102, there is an advantage in that it is possible to attach the heat dissipation member 2 to the motor 102 without using bolts and to efficiently cool the motor 102.

Note that, in the above-described embodiment, although a description has been given of a case in which the heat dissipation members 2 are attached to the motor 102 without using bolts, as shown in FIG. 2, there is a case in which a screw hole 12 to which a lifting phase bolt or the like is attached is provided in the side surface 103 of the motor 102. In that case, it is also possible to use the phase-bolt screw hole 12 to fix at least one fixing member 3 to the motor 102. Accordingly, the elastic restoring force of the fixing member 3 can be used mainly to bring the heat dissipation members 2 into close contact with the side surfaces 103 of the motor 102, and attachment of the heat dissipation members 2 with respect to the motor 102 can be more reliably achieved with a bolt.

Furthermore, in this embodiment, although a description has been given of the cooling structure 1, which is attached to the motor 102 for rotating the turning body 101, as an example, instead of this, the present invention may be applied to a cooling structure 1 that is attached to a motor 102 for pivoting an arm about a horizontal axis.

In this case, the fins 5 may be disposed so as to extend in vertical directions, to facilitate air natural convection, thus improving the cooling efficiency. Furthermore, in a case in which the motor 102 is disposed at a position where the motor 102 itself is moved due to the movement of each axis, the fins 5 may be disposed in such a direction that a flow of air around the fins 5 due to the movement is not disturbed.

Furthermore, it is needless to say that, in order to increase the degree of close contact between the side surfaces 103 of the motor 102 and the heat dissipation members 2, a gap therebetween may be filled with a sheet or grease that is made of a material excellent in thermal conductivity.

Furthermore, the heat dissipation member 2 is not limited to that having a number of fins 5, and a heat dissipation member 2 having another arbitrary shape may be adopted.

Furthermore, although the heat dissipation member 2 having the fins 5 is adopted in order to dissipate the heat of the motor 102 to the air, it is also possible to adopt a heat dissipation member 2 that performs heat dissipation by being brought into contact with a section, such as a body of the robot 100, having a lower temperature than the motor 102 and that is formed of a material or a heat pipe having high thermal conductivity.

As a result, the above-described embodiment leads to the following aspect.

One aspect of the present invention is directed to a robot-motor cooling structure including: at least one heat dissipation member that is disposed on a surface of a motor for a robot and that is made of a material having higher thermal conductivity than the motor; and at least one fixing member that is made of an elastic material capable of being elastically deformed and that is disposed at a position so as to surround the motor together with the heat dissipation member, wherein the heat dissipation member is brought into close contact with the surface of the motor by an elastic restoring force of the fixing member.

According to this aspect, the heat dissipation member is disposed on the surface of the motor for the robot, the fixing member is disposed at a position so as to surround the motor together with the heat dissipation member, and the fixing member is mounted on the motor in an elastically deformed state, thereby biasing the heat dissipation member due to the elastic restoring force of the fixing member so as to be in close contact with the surface of the motor. Accordingly, the heat generated at the motor is transferred to the heat dissipation member and is effectively dissipated from the heat dissipation member, which has high thermal conductivity, to the outside, thus making it possible to cool the motor. In this case, it is not necessary to provide a screw hole in the surface of the motor in order to bring the heat dissipation member into close contact with the surface of the motor, thus making it possible to save time and effort for machining. Accordingly, the heat dissipation member can easily be attached to a general-purpose motor in which a screw hole is not prepared in a side surface thereof etc.

In the above-described aspect, two of the heat dissipation members may be disposed at both sides of the motor with the motor sandwiched therebetween; and the fixing member may be disposed so as to connect the two heat dissipation members at both sides of the motor with the motor sandwiched therebetween.

By doing so, the two heat dissipation members disposed at both sides of the motor with the motor sandwiched therebetween are biased in directions in which the two heat dissipation members come close to each other, by an elastic restoring force of the fixing member, which connects the heat dissipation members, thus being simultaneously brought into close contact with both side surfaces of the motor, which is disposed therebetween. Accordingly, the two heat dissipation members are simply attached to the motor in a close contact state without forming a new screw hole, thus making it possible to achieve effective cooling.

Furthermore, in the above-described aspect, the fixing member may be formed of a plate spring.

By doing so, it is possible to dispose the fixing member so as to fit along the surface of the motor and to suppress an increase in the dimension around the motor. Accordingly, interference with an arm of the robot etc. can be easily avoided.

Furthermore, in the above-described aspect, the fixing member may be provided with a coil spring.

By doing so, the coil spring, which forms the fixing member, is disposed along a side surface that is adjacent to the side surface of the motor with which the heat dissipation member is brought into close contact, thereby making it possible to easily and more reliably bring the heat dissipation member into close contact with the side surface of the motor due to the elastic restoring force of the coil spring.

According to the present invention, an advantageous effect is afforded in that heat generated by a motor can be effectively cooled without forming, in a side surface of the motor, a new screw hole for fixing a heat sink.

### REFERENCE SIGNS LIST

2 heat dissipation member
3, 10 fixing member
11 coil spring
102 motor
103 side surface (attachment surface, surface)

1. A robot-motor cooling structure comprising:
at least one heat dissipation member that is disposed on a surface of a motor for a robot and that is made of a material having higher thermal conductivity than the motor; and
at least one fixing member that is made of an elastic material capable of being elastically deformed and that is disposed at a position so as to surround the motor together with the heat dissipation member,
wherein the heat dissipation member is brought into close contact with the surface of the motor by an elastic restoring force of the fixing member.

2. The robot-motor cooling structure according to claim 1, further comprising two heat dissipation members disposed at both sides of the motor with the motor sandwiched therebetween; and
the fixing member is disposed so as to connect the two heat dissipation members at both sides of the motor with the motor sandwiched therebetween.

3. The robot-motor cooling structure according to claim 1, wherein the fixing member is formed of a plate spring.

4. The robot-motor cooling structure according to claim 1, wherein the fixing member is provided with a coil spring.
